(19) United States
(12) Patent Application Publication
(10) Pub. No.: US 2024/0000104 A1
(43) Pub. Date: Jan. 4, 2024

(54) PROTEIN PREPARATION PRODUCED FROM HEMP SEEDS AND PREPARATION METHOD

(71) Applicant: Fraunhofer-Gesellschaft zur Förderung der Angewandten Forschung E.V., München (DE)

(72) Inventors: Peter EISNER, Freising (DE); Andreas STÄBLER, Freising (DE); Stephanie MITTERMAIER, Freising (DE); Dominic WIMMER, Freising (DE); Klaus SCHREIBER, Freising (DE); Isabel MURANYI, Freising (DE)

(21) Appl. No.: 18/253,958

(22) PCT Filed: Nov. 18, 2021
(86) PCT No.: PCT/EP2021/082078

§ 371 Date: May 23, 2023

(30) Foreign Application Priority Data
Nov. 24, 2020 (DE) 10 2020 131 027.7

(51) Int. Cl. A23J 1/14; A23J 3/14; A23J 3/34; A23L 33/185; A23K 20/147; B01D 11/02; A23L 2/66

(52) U.S. Cl. CPC A23J 1/142; A23J 3/14; A23J 3/346; A23L 33/185; A23K 20/147; B01D 11/0288; A23L 2/66

(57) ABSTRACT

The present invention relates to a protein preparation produced from hemp seeds and to a cost-effective method for the preparation thereof. The protein preparation has a protein content or more than 65% by mass, a fat content of less than 6% by mass and a brightness L* of greater than 70. The protein preparation has a neutral taste, is bright and of superior quality so that it is suitable for foodstuff applications with high colour demands such as vegetable dairy alternatives (drinks, yoghurt, cheese) or bright vegetable alternatives to meat, poultry or fish.

### FIELD OF APPLICATION

The invention relates to a protein preparation produced from hemp seeds as an ingredient for foodstuffs, petfood and animal feed that is appealing to the senses, and a method for obtaining hemp protein ingredients of such kind.

### PRIOR ART

As farmland and phosphorus resources become increasingly scarce and CO₂ emissions from agriculture continue to rise, plant-based protein preparations are becoming more and more important for feeding humans and for use in animal feed. The growing demand for superior quality foodstuffs gives rise to an increasing need for nutritionally and technofunctionally optimised protein preparations that can be provided simply and inexpensively.

In this context, vegetable proteins that can be mixed as a blend component with soya and pea proteins in order to compensate for the methionine deficiency in these protein preparations are becoming increasingly important. This may be achieved with proteins from oil seeds for example.

A cost-effective source of proteins for foodstuffs, animal feed and petfood are press and extraction residues obtained as by-products when cooking oil is produced from hemp seeds. Hemp seeds have a firm shell with predominantly dark green and brown pigmentation, and enclose an oil-containing pulp. The shells of these primary products can only be separated partially before recovering the oil, until now the shells are not separated completely, or even mostly, because this would have a significant, negative impact on oil yield and the pressing speed. For this reason, when pressing to recover hemp oil according to the prior art, the seeds used are entirely or partially unshelled, with a shell fraction well over 10% by mass, usually over 20% by mass. At high temperatures of more than 100° C., press cakes are then obtained with an oil content less than 15% by mass, often less than 10% by mass. These can be ground into a powder and added to foodstuffs and animal feed. Because of the harsh treatment at high temperatures, the technofunctional properties such as gel formation of the protein are inferior. The high shell content also lends the press cakes a greenish-brown colour, which reduces their acceptance in food applications. Due to the unsaturated fatty acid content, the residual fat in the oil-containing press cake also tends to oxidise, which impairs the sensory characteristics very quickly during storage. Compared with isolates from soya (protein content >90%) or pea (protein content >80%), hemp preparations of such kind also have a protein concentration of less than 60% by mass, in some cases even considerably below 50% by mass (see for example Potin et al., “Hemp “Cannabis sativa L.) Protein Extraction Conditions Affect Extraction Yield and Protein Quality”, Journal of Food Science 2019, Vol. 84, Iss. 12, pages 3682-3690; Q. Wang et al., “Processing, Nutrition, and Functionality of Hempseed Protein: A Review”, Comprehensive Reviews in Food Science and Food Safety 2019, Vol. 18, Iss. 4, pages 936-952; The et al., “Effect of the defatting process, acid and alkali extraction on the physicochemical and functional properties of hemp, flax and canola seed cake protein isolates”, Journal of food measurement & characterization 2014, Vol. 8 No. 2, pages 92-104), which makes them difficult if not impossible to use in many foodstuff applications.

Otherwise, preparations from partially shelled hemp seeds are known in the prior art, the colour of which does not turn out quite as dark (L* <50; Teh et al. 2014, see above). But here too, storage stability is unsatisfactory because of the high residual oil content.

Hemp preparations are also known in which the fat content is reduced to values below 2% by mass with supercritical CO₂ after pressing, which improves storage stability. However, this method entails very high costs. Moreover, the extraction takes place at high pressure of several hundred bar in very expensive reactors, the manufacture and operation of which is associated with high CO₂ emissions. Since the process requires a great deal of energy, and after relaxation large quantities of CO₂ are released from the de-oiled flour, protein flours that are extracted by means of supercritical CO₂ have no clear ecological advantages over animal proteins and also entail similarly high costs for their preparation.

The object of the present invention consisted in providing a vegetable protein preparation that has a neutral taste, a bright colour and superior quality, and a cost-effective preparation method, which is suitable for use in foodstuff applications with high colour demands such as vegetable dairy alternatives (drinks, yoghurt, cheese) or bright vegetable alternatives to meat, poultry and fish. The protein content of the preparation should advantageously be as high as possible, so that even in small amounts it contributes to protein enrichment in foodstuffs, or even in smaller doses it helps to compensate for the methionine deficit when mixed with leguminous protein.

### DESCRIPTION OF THE INVENTION

The object is solved with the protein preparation according to claim 1 and the preparation method therefor according to claim 15. Advantageous variants of the method and the protein preparation are described in the subordinate claims as well as the following description and the exemplary embodiment.

Suitable raw material for manufacturing the protein preparation according to the invention may consist of cleaned and partially or completely shelled hemp seeds with a shell content less than 18% by mass, preferably less than 10% by mass, advantageously less than 5% by mass, more preferably less than 2% by mass, particularly advantageously less than 1% by mass relative to the mass of the raw substance. The preparation according to the invention is characterized by the following properties (the methods of determination are listed at the end of the description):
The fat content of the preparation is less than 6% by mass, advantageously less than 4% by mass, preferably less than 3% by mass, particularly advantageously less than 2% by mass, in each case relative to the dry matter or dry substance (DS) of the preparation.
The protein content of the preparation is more than 65% by mass, advantageously more than 70% by mass, preferably more than 75% by mass, particularly advantageously more than 80% by mass (relative to DS).
The preparation has a bright to white colour both in the dry form and in aqueous suspension, wherein the L* value after grinding to a particle size d₉₀ (d₉₀:
fraction of 90% of the mass of all particles less than the value specified) below 250 μm is more than 70, advantageously more than 80, preferably more than 90, particularly advantageously more than 92. The L* value in a 10% aqueous suspension is more than 70, advantageously more than 80, preferably more than 90, particularly advantageously more than 92 (see Table 1).

### Preferred (Optional in Each Case) Additional Properties of the Preparation:

The preparation contains a residual hemp seed content of less than 36% by mass, preferably less than 20% by mass, more preferably less than 10% by mass, particularly preferably less than 4% by mass or less than 2% by mass.
The preparation contains a fraction of water-soluble carbohydrates. Since sucrose constitutes the largest part of the water-soluble carbohydrates, in the following they will be indicated as sucrose content. The sucrose content is less than 8% by mass, advantageously less than 3% by mass, preferably less than 1% by mass, particularly advantageously less than 0.65% by mass.
The preparation has an ash content (relative to dry matter after treatment at 550° C.) of more than 5% by mass, preferably more than 10% by mass, particularly advantageously more than 15% by mass. This shows that the carbohydrate fraction is very small. This means that the obstruction of gel formation in foodstuffs due to high fractions of carbohydrates and fibre can be largely avoided.
The particle size of the preparation has a d₉₀ value smaller than 500 μm, preferably smaller than 250 μm, advantageously smaller than 150 μm, particularly advantageously smaller than 100 μm.
The preparation has technofunctional properties, in particular an emulsifying capacity greater than 125 mL/g, advantageously greater than 200 mL/g, more preferably greater than 300 mL/g, particularly advantageously greater than 400 mL/g. Moreover, at pH 7 the preparation has a protein solubility between 8% and 50%, advantageously between 9% and 20%, particularly advantageously between 9% and 15%. Surprisingly, despite a solubility which in some cases is less than 15%, preparations according to the invention are found to be highly suitable a ingredients for extruded vegetable proteins, e.g., as wet texturised meat substitute or dry texturate.
The preparation contains fractions of alcohol, in particular ethanol, more than 0.001% by mass, preferably >0.01% by mass, advantageously >0.1% by mass, particularly advantageously >0.4% by mass, but in all cases less than 1% by mass. In this context, it was found that the functional properties of the preparation are at a very high level even with a content of 0.5% by mass. Optionally, the preparation contains fractions of hexane greater than 0.0005% by mass, preferably >0.001% by mass but less than 0.005% by mass. Preparations with hexane contents of this order exhibit better functional properties in comparison to preparations with lower hexane content.

With respect to the properties of the preparation in the present patent application, the values stated in % by mass refer in each case to the dry matter or dry substance of the protein preparation, with the exception of the solvent fractions, which are specified as an absolute mass fraction.

TABLE 1
Colour values for hemp protein preparation of the exemplary
embodiment as flour and in a 10% suspension

| | Colour value | | |
|---|---|---|---|
| Colour values | L* | a* | b* |
| Hemp protein preparation as flour | 92.4 | −0.8 | 7.5 |
| Aqueous suspension with 10% by mass flour | 92.6 | −0.2 | 16.6 |

Surprisingly, solvent-containing preparations with the stated solvent contents still exhibit very good properties in terms of technofunctionality, such as the ability to be textured in the extruder with the formation of solid gel structures, although the protein content is in the same order of magnitude as for protein isolates (e.g., pea protein isolates), which exhibit significant loss of functionality in the presence of solvents such as ethanol.

In advantageous variants, the preparation has additional properties, which can be of great benefit in various food applications. For example, the amount of sucrose originally contained in the seeds may be reduced after the application of suitable methods, so that the ratio of proteins to soluble carbohydrate contents is significantly greater in the protein preparation than in shelled hemp seeds. This may bring advantages in terms of avoiding the initiation of undesirable Maillard reactions when manufacturing foods, as Maillard products change the colour of the food that is produced with the proteins, lending the food a darker appearance. This is undesirable, particularly for foodstuffs such as milk or yoghurt alternatives or poultry and fish alternatives. Accordingly, the hemp protein preparation according to the invention, which in this case also low in sucrose, is particularly well suited for use in the preparation of bright foodstuffs such as vegetable dairy, poultry or fish alternatives, which the consumer expects to be brightly coloured.

It has been found that a reduction of the sucrose content in the protein preparation relative to the sucrose content in the raw substance to values below 50% significantly reduces the discolourations, e.g., in the course of an extrusion of the protein at temperatures above 130° C., and the extruded product ends up lighter and more neutral to the senses than when a preparation is extruded with the amount of sucrose originally contained in the seeds. In this way, it is possible to produce very bright extrudates, which may be used as poultry or fish alternatives. The effect of the colour advantage is already perceptible even when the sucrose content in the protein preparation is reduced to values below 80% relative to the sucrose content in the raw material if this ratio is reduced to less than 25%, preferably less than 10%.

Surprisingly, it is possible to achieve protein contents of more than 80% by mass in the preparation according to the invention—after advantageous performance of the method according to the invention—, without dissolving the proteins in water beforehand, as is necessary when producing protein isolates according to the prior art. In this way, protein contents which are otherwise only known from isolates, e.g., pea protein isolates may be obtained using a very simple, cost-effective and extremely sustainable method without dissolving the proteins out of the press cake matrix.

### Description of the Method for Preparing the Protein Preparation:

The method according to the invention includes a number of substeps, wherein cleaned hemp seeds from which shells and teguments have been removed or correspondingly cleaned hemp seeds are provided, and then undergo a mechanical de-oiling process, preferably in a continuous or quasi-continuous press such as a screw press, an extruder, or a hydraulic press, the press cakes or partially de-oiled hemp seeds obtained then have most of their oil and sucrose content removed by solvent extraction using alcohol and water, in particular mixtures thereof, or hexane and water, advantageously after setting a defined particle size and setting a defined water content in the press cake or partially de-oiled hemp seeds. Then, the one or more solvent(s) is/are separated precipitated out of the preparation. To conclude, the preparation is preferably ground to achieve a defined particle size distribution. The process may advantageously be accompanied by sieving, sifting and sorting processes, which enable a separation of shell and tegument fractions before, during or after processing of the seeds. The following section describes the substeps of the suggested method in greater detail, some of which are optional.

Cleaning: In a first step, cleaned hemp seeds are provided, or impurities or contaminants such as grit, straw, extraneous seeds, or other contaminants are removed from hemp seeds by mechanical methods. The fraction of contaminants is thus reduced to less than 0.5% by mass, advantageously less than 0.2% by mass, preferably less than 0.1% by mass, particularly advantageously less than 0.05% by mass, and/or hemp seeds with a corresponding low contaminant fraction are provided.

Shelling: In the following step, the cleaned hemp seeds are shelled or shelled hemp seeds are provided. After shelling and before further processing to obtain the preparation colour according to the invention, the fraction of shells and teguments constitutes less than 18% by mass, preferably less than 10% by mass, advantageously less than 5% by mass, more preferably less than 2% by mass, particularly advantageously less than 1% by mass. Even though this extensive shell separation make pressing as the preferred form of mechanical partial de-oiling much more difficult, this step creates the basis which makes it possible to achieve a brightness value L* of over 90 in the finished preparation. As part of the shelling step, a sorting process is preferably also carried out in order to separate individual (darker) seeds or remaining shell fractions out of the stream of shelled seeds by means of a compressed air blast or by suction. This may also be performed with an optical or another continuous, automatic sorting system based on the detection of reflections from electromagnetic radiation from the seed surface. Although this method reduces the yield, since many shelled particles are separated as well, automated sorting before subsequent processing further improves the brightness and homogeneity of the finished preparation and acceptance thereof.

Mechanical partial de-oiling: After shelling, optionally including a sorting process, a mechanical separation of the oil from the seeds is carried out, advantageously with apparatuses for continuous de-oiling. Examples of such machines are presses such as screw presses, extruders or quasi-continuous hydraulic presses, but other mechanical apparatuses for separating oil may also be used, such as centrifugal separating technologies. In the particularly advantageous compression of the seeds to yield press cakes and oil using screw presses or extruders, the pressing is performed in such manner that the residual oil content after pressing is more than 8% by mass but less than 40% by mass, the residual oil content is advantageously between 8 and 30% by mass, preferably between 8 and 25% by mass, and particularly advantageously between 8 and 20% by mass. The definition of the lower limit of 8% by mass residual oil content is chosen because further oil separation requires considerably higher temperatures, which may be instrumental in in damaging the proteins. These values are also valid if presses are not used, but other types of mechanical partial de-oiling are used instead.

Shelled hemp seeds have a high oil content of as much as 60%, and because they lack shells for drainage, it is not easy to de-oil them mechanically. However, in order to reduce the quantity of solvent needed for de-oiling, the objective is to reach a residual oil content of less than 20% by mass in the press cake after pressing or in the partially de-oiled hemp seeds. For this reason, it may be necessary to press the press cake in a press again or carry out another mechanical partial de-oiling process. This may be carried out during the pressing, for example by adding the press cake to the feed for the first pressing together with unpressed seeds, or in another, second press, which is only used to press the press cake further. The pressing of the press cake may also be carried out multiple times in order to arrive at the desired residual oil content. With repeated pressing of press cakes or repeated mechanical partial de-oiling, it is possible in the end to achieve the desired low residual oil content without having to set excessively high temperatures. To avoid damaging the proteins too severely through repeated mechanical partial de-oiling, according to the invention pressing or mechanical partial de-oiling take place at moderate temperatures. The hemp seeds are pressed or mechanically partially de-oiled at a mean temperature below 100° C., advantageously below 80° C., preferably below 60° C. In this context, the mean temperature is understood to be the arithmetical average of the temperature of the seeds at the intake and the temperature of the press cakes or partially de-oiled hemp seeds at the discharge from the press or mechanical partial de-oiling device. This enables gentle pressing and separation of the oil despite several passes through the press or mechanical de-oiling device, without having to anticipate any significant colour changes in the preparation. In an advantageous variant, a conditioning of the seeds is carried out before the mechanical partial de-oiling, with adjustment of the temperature and moisture of the seeds. For this, the water content in the seeds is adjusted to between 2 and 8% by mass, preferably between 3 and 6% by mass, particularly advantageously between 4 and 5.5% by mass, and the temperature is adjusted to values between 30° C. and 80° C., advantageously between 40 and 60° C., particularly advantageously between 45° C. and 55° C.

Optional pre-cooling and interim cooling: In a further variant of the method, the seeds are cooled before or during the mechanical pretreatment (consisting of shelling, sorting, pressing or mechanical partial de-oiling) to a temperature below 20° C., advantageously below 10° C., preferably below 0° C., more preferably below −10° C., particularly advantageously below −15° C. It has been found that lowing the temperature makes it easier for the mechanical steps such as shelling and sorting to be carried out, with the result that the yield can be increased in the process, for example because the losses due to already shelled hemp seeds being blown out during sorting are reduced, or the seeds do not form such large accretions on the system components. Moreover, after the temperature is lowered significant quality improvements are realised due to decreased lipidoxidation. Advantages may also be realised for the first step of the mechanical partial de-oiling in the case of pressing by cooling the seeds ahead of the press, since the intake into the press is less prone to clogging at low temperatures. In order to cool the seeds, cooling tunnels may be used, or the seeds may be cooled with cold air, a cold inert gas or liquid nitrogen.

Optional conditioning of the press cake or partially de-oiled hemp seeds: In an advantageous variant of the method according to the invention, a conditioning of the press cakes or partially de-oiled hemp seeds may be carried out to separate the remaining oil and reduce the fraction of sucrose in the press cakes or partially de-oiled hemp seeds in advance of any further processing. In such a case, it has been found that a reduction of the moisture in the press cakes or partially de-oiled hemp seeds, which may be as much as 15% by mass after the mechanical partial de-oiling, to a residual moisture below 8% by mass, advantageously below 5% by mass, preferably below 3% by mass, particularly advantageously below 2% by mass, using dryers for example, makes the de-oiling with organic solvents in the subsequent step more efficient, by enabling more oil to be separated using less solvent with lower moisture. This may be used advantageously to lower costs and to enable gentler treatment of the proteins.

It may further be of advantage to change the particle size and particle shape of the press cakes or partially de-oiled hemp seeds before the extraction. It has been found that crushing the press cake or partially de-oiled hemp seeds to particle sizes with a d₉₀ value less than 2 mm, advantageously less than 1 mm, preferably less than 0.5 mm, particularly advantageously less than 0.2 mm, significantly accelerates the drying and extraction process. This acceleration leads to an improvement of the functional properties in the preparations, since the residence time in the dryer and the contact time between solvent and proteins are shortened. But according to the invention, the fraction of fine grain with a particle size less than 100 μm in the crushed press cake or hemp seed bulk material should be less than 50% by mass, advantageously less than 25% by mass, particularly advantageously less than 10% by mass.

It is also possible, and for a percolation extraction advantageous, if the press cake or the partially de-oiled hemp seeds is or are not ground, but flaked. In such a case, the flake thickness is advantageously adjusted to less than 2 mm, preferably less than 0.5 mm, particularly advantageously less than 0.2 mm. In this context, flake thickness is understood to refer to the average thickness of the particles emerging from the roller mill or another flaking machine. The average thickness can be determined for example by measuring with a calliper gauge or a micrometer screw, which then corresponds to the average from 50 measurements.

The particle size and particle shape of the press cake during mechanical partial de-oiling with a press can be adjusted using various processes. For example, mills or crushers with corresponding sieve inserts or roller mills with defined roller gaps may be used. In this context, particle size distributions with a defined size spectrum may be obtained. These may be homogenised with regard to particle size distribution after or during the grinding by separation according to size, for example by sieving. Fast-flowing liquids in the form of a pressure jet or suspensions containing solids may also be used to comminute the press cake particles. Here, besides liquid nozzles, conveyor units, agitators or mixers with a shearing load of the press cake may also be used. Machines that are already in use in the process for transporting the extraction agent are advantageously used for this as well. Thus, it is possible to use machines that were actually designed for pumping or agitation, for example centrifugal pumps or other forms of transport or agitation machinery, to assist with crushing. By setting a suitable residence time in these units, or by cycle management, it will be possible to adjust the crushing in said devices such that the particle size distribution according to the invention is obtained.

Solvent extraction: In order to separate residual oil and sucrose from the press cakes or mechanically partially de-oiled hemp seeds, mixtures of alcohols with water as solvent are used for preference. Combinations of alcohol as one solvent and water as another solvent may also be implemented. The use of alcohol or hexane, each in the presence of water, is also possible. In this case, the treatment with the organic solvent and the treatment with water can be carried out simultaneously, in the same extraction step (e.g., in the form of an alcohol-water mixture), or consecutively. Ethanol, propanol, isopropanol, for example, or others may be used as alcohols. In order to ensure a substantial separation of the oil out of the press cakes or partially de-oiled hemp seeds, the mass fraction of organic solvent relative to the mass fraction of press cake or partially de-oiled hemp seeds should be chosen to be more than 1.5 to 1, advantageously more than 3 to 1, preferably more than 5 to 1, more preferably more than 7 to 1, particularly advantageously more than 10 to 1. It is then possible to achieve a substantial reduction of the oil to less than 2% by mass and a reduction of the sucrose to less than 1% by mass.

When the organic solvent is used for the extraction, it is advantageous if a quantity of water is added or an organic solvent with a defined water content is used besides the organic solvent. In such a case, the water may be used while the oil is being extracted with the solvent or not until afterwards. In the event of simultaneous use of organic solvent and water and selection of a suitable water content, not only is it possible to separate a very large proportion of the fat from the press cakes or hemp seeds, but the sucrose can also be removed at the same time. For this purpose, the water content in the extraction is chosen to be more than 6% by mass, advantageously more than 7% by mass, particularly advantageously more than 8% by mass, preferably more than 10% by mass relative to the organic solvent. In the case that alcohols are used as the organic solvent, the water content should be chosen to be more than 6% by mass but less than 14% by mass to avoid the situation in which the oil can no longer be dissolved sufficiently. This limitation makes it possible to obtain a technofunctional protein preparation which has a particularly bright colour and a very high protein content.

The addition of the water to the organic solvent may be carried out by providing aqueous solvent, an alcohol-water mixture for example, by adding sufficiently moist press cake or moist hemp seeds, or by adding water directly before or during the solvent extraction. Combinations of the measures described may also be selected.

During the treatment of protein-rich press cakes produced from hemp with water-alcohol mixtures simultaneously with the separation of the oil and sucrose it is also possible for the proteins to become denatured. In order to largely avoid this effect, only a small process window is available for this simultaneous separation step. This includes not only the defined water content, but also the temperature and the residence time. According to the invention, the temperature of the solvent during the extraction will be between 30° C. and 75° C., advantageously between 45° C. and 65° C., particularly advantageously between 50° C. and 65° C. At this temperature, the selected mixtures of water and organic solvent are able to separate both oil and sucrose from the hemp seeds without at the same time causing excessive denaturation of the proteins. In the method according to the invention, the duration of the contact between organic solvent and the press cake or protein preparation at temperatures above 45° C. is between 30 minutes and 12 hours, advantageously between 1 hour and 5 hours, particularly advantageously 1 to 2 hours. However, the temperature ranges stated above should also be chosen if hexane is used as solvent, in order to avoid thermal damage to the proteins to the extent possible.

For the extraction, a conventional percolation extraction may be implemented, in which the solvent is passed over a bulk quantity of press cake particles or particles that have been conditioned in terms of particle size/shape or moisture, so that oil and sucrose can be eluted into the organic solvent and/or the water. Since fine particles can be detached from the hemp seed press cakes and washed out with the solvent in this process, extensive filtration apparatuses must be provided to prevent pumps and pipelines from becoming clogged or to avoid product losses. In order to suppress this process, or at least to limit it, it may be advantageous to press the conditioned or unconditioned press cakes into pellets before the extraction, as considerably fewer fine particles become detached from these during the extraction. In this way, the expense of the filtration may be reduced significantly.

Since a loss of fine particles cannot be entirely prevented during the percolation extraction, it is advantageous to perform an immersion extraction, preferably in a mixing-settling process for example. A multistage immersion extraction is particularly well suited for this. In this process, the press cakes or conditioned press cakes are completely immersed in the solvent. In an immersion extractor, it is possible to comminute the particles with an agitator as described above simultaneously with the extraction. In this way, it is also possible to perform an incremental crushing of the press cakes in several extraction receptacles arranged one behind the other. Following the first extraction step, solvent and raffinate can be separated mechanically, advantageously by sedimentation. The oil-containing miscella in the supernatant can subsequently be distilled and rectified, and the recovered solvent can be reused for the extraction of press cake particles with a finer particle size distribution. The press cake (raffinate) separated by solvent may be reacted with fresh solvent, and so undergo de-oiling again. In order to reduce the total quantity of solvent, the solvent supernatant from the treatment of a raffinate charged with less oil may be used again for the extraction of a raffinate charged with more oil, and so on. In this way a counterflow extraction is established with agitation vessels. Alternatively, a counterflow extraction may also be created in a screw, chamber or belt extractor.

A particular advantage of the use of sedimentation is derived from the capability to specify the duration of the sedimentation for adjusting the degree of separation for solid-liquid separation. In this context, following an extraction carried out with defined particle sizes, after the agitator is stopped a sedimentation takes place in the earth's gravity field until a defined volume ratio of raffinate and supernatant is reached. This process may advantageously be supported by a filter floor or sieve floor that accelerates or retards the sedimentation of the particles from above, or by generation of a vacuum underneath a filter below the sedimentation layer (strainer for example). During the sedimentation, it is advisable to separate the supernatant from the raffinate, by suction for example, when a previously defined volume fraction of the supernatant of at least 50%, advantageously more than 60%, particularly advantageously more than 70% is reached.

In the counterflow, the raffinate can be recharged with solvent and the suspension can be agitated until a new particle size distribution is established by the shear forces created during the agitation. The sedimentation process then takes place again. The process of mixing and settling of the raffinate may be repeated multiple times, advantageously the process is performed more than twice, preferably more than three times, particularly advantageously more than four times, with the result that the extraction is performed as a multistage extraction particularly advantageously in the counterflow. In this context, in a variant of the method it is advantageous to use different mixing ratios of organic solvent and water in different stages of the multistage extraction. For example, a higher water content may be used in the first extraction stage in order to selectively separate water-soluble components, and in subsequent extraction steps the water content may be lower to make the de-oiling more efficient, since a solvent like ethanol or propanol for example can dissolve more oil with a lower water fraction. This approach also has the advantage, when using ethanol as solvent for example, that the water content is only high for a short time in the first extraction stage, and consequently the protein denaturation can be minimised. It was found that with hemp seeds denaturing of the proteins may be reduced if solvents or solvent mixtures with different polarities are used in different extraction stages.

Apart from the mixture of water and an alcohol such as ethanol in an extraction step, it may also be advantageous to use a lipophilic solvent initially, and then to introduce a hydrophilic or water-containing solvent after partial separation of the solvent or complete desolvation of the raffinate. This may serve to further reduce the stress on the proteins due to the presence of water and alcohol.

Post-treatment and desolvation of the preparation: Following the extraction with the one or more organic solvents and water, in order to improve its functional properties the preparation may optionally undergo further treatment with aqueous enzyme solutions or fermentation, or it may be dried directly. Drying is advantageously performed at low temperatures, below 120° C., preferably below 100° C., particularly advantageously below 80° C., in order to minimise stress on the proteins and preserve the brightest possible colour in the preparation. For this purpose, advantageously a dryer is used that can be operated in a vacuum and whose pressure is lowered again at the end of the drying process to separate the solvent residues. The pressure is advantageously reduced to values less than 500 mbar, preferably less than 200 mbar, particularly advantageously less than 100 mbar. This pressure reduction at the end of the drying process may serve to lower the temperature further during the post-drying period, thereby ensuring further gentle treatment of the proteins.

After drying, the dried protein preparations are advantageously ground to adjust their functionality, as preparations ground to different degrees of fineness exhibit significant differences in their technofunctional properties, such as emulsifying capacity. Grinding therefore takes place depending on application to d₉₀ particle sizes less than 500 μm, advantageously less than 250 μm, preferably less than 150 μm, particularly advantageously less than 100 μm.

### Description of a Use of the Preparation:

When the protein preparation produced from hemp seeds according to the invention is used, particular advantages are revealed for the preparation of protein mixtures for foodstuffs or petfood. A mixture of the preparation according to the invention with protein fractions of leguminous protein from the group of peas, lentils, beans, broad beans, peanuts or soya is advantageous, only from the group of peas and soya is particularly advantageous, only soya is especially advantageous. The reason for soya as additive for the preparation according to the invention is in the bright colour of soya protein isolates, as the particularly bright preparation according to the invention is not so striking in a mixture with darker leguminous proteins. A mixture according to the invention should contain >60%, advantageously >70%, particularly advantageously >80% by mass protein content. The ratio of the protein according to the invention relative to the total mass of the mixture should be more than 5% by mass and less than 95% by mass, advantageously more than 10% by mass and less than 90% by mass, particularly advantageously more than 25% by mass and less than 75% by mass, ideally more than 40% by mass and less than 60% by mass. Accordingly, the functionality of the leguminous proteins may be combined particularly successfully with the good sensory appeal and colour of the preparation according to the invention.

In the text below, the following determination methods are used to present a quantitative characterisation of the protein preparations produced:

### —Protein Content:

Protein content is defined as the content calculated from the determination of nitrogen according to Dumas and multiplying this by a factor of 6.25. In the present patent application, the protein content is expressed in percent by mass relative to the dry matter (DM), that is to say the anhydrous sample.

### —Colour:

Perceptible colour is defined using CIE-L*a*b* colour measurement. The L*-axis describes brightness, wherein black has value 0 and white has value 100. The a*-axis describes the green or red component, and the b*-axis describes the blue or yellow component.

### —Protein Solubility:

Protein solubility is determined using determination methods according to Morr et al. 1985, see the magazine article: Morr C. V., German, B., Kinsella, J. E., Regenstein, J. M., Van Buren, J. P., Kilara, A., Lewis, B. A., Mangino, M. E, “A Collaborative Study to Develop a Standardized Food Protein Solubility Procedure. Journal of Food Science”, Volume 50 (1985) pages 1715-1718). Protein solubility can be stated for a defined pH value, if no pH value is given, the data refers to a pH value of 7.

—Emulsifying Capacity:

Emulsifying capacity is defined using determination methods (referred to in the following as EC determination methods) in which corn oil is added to 100 ml of a 1% suspension of the protein preparation with pH 7, until phase inversion of the oil-in-water emulsion occurs. Emulsifying capacity is defined as the maximum oil absorption capacity of this suspension, determined via the spontaneous fall in conductivity upon phase inversion (see the magazine article by Wäsche, A., Mtiller, K., Knauf, U., “New processing of lupin protein isolates and functional properties”. Nahrung/Food, 2001, 45, 393-395) and is expressed for example in ml oil/g protein preparation, i.e. millilitres of emulsified oil per gram of protein preparation.

### —Fat Content:

Fat content is determined with the Soxhlet method using hexane as solvent.

### —Sucrose:

The sucrose content is determined by modified measurement according to DIN 10758:1997-05 (incl. amendment 1 of September 2018) with HPLC methods. To prepare the samples, the sugars are extracted from the sample matrix using hot water. After separating contaminants, the extracts are filled with water to a defined volume, filtered, and the filtrates are forwarded for HPLC measurement.

### Exemplary Embodiment

200 g of a hemp press cake with a shell content of 0.5% by mass and an oil content of 25% by mass, which was obtained with the aid of a press at an average temperature of 65° C. with three passes through the press was dried in a dryer to obtain a water moisture content of 3% by mass, and the press cake was coarsely ground into pieces measuring roughly 1 mm in a mortar. The crushed press cake was extracted 5 times, using 800 mL solvent (ethanol-water mixture with 7% by mass water content) each time. For this in the first stage 800 mL was added to the 200 g press cakes, stirred for 5 minutes at 50° C., then the agitator was switched off. The solid was allowed to settle for 30 minutes, then 500 mL of the supernatant was drawn off, and 800 mL solvent was added to this again. The following extraction steps were performed in the same way, 800 mL was added and 800 mL was drawn off each time. Then, the final raffinate or sediment was dried for 24 hours in a drying cabinet and subsequently sieved through a sieve with 1 mm mesh size. With sieving, it was possible to separate further shell fractions, which could not be removed before the pressing, so that the brightness of the preparation was further improved. Sieving was followed by grinding to smaller than 250 μm.

The preparation had a protein content of 78.6%, an oil or fat content of 3.8%, a sucrose content of 0.6%, a protein solubility of 13.2% at pH 7 and an emulsifying capacity of 223 mL/g. The L*a*b measurement returned an L* value of 92. Accordingly, the preparation is ideally suitable for very bright foodstuff applications. The following Tables 2 and 3 present the composition and functional properties of this preparation.

TABLE 2
Composition of the hemp protein preparation compared
with the composition of hemp seeds before treatment

| | | Ash | Ash | | | |
|---|---|---|---|---|---|---|
| | DM | (550° C.) | (950° C.) | Protein | Oil | Sucrose |
| Preparation | [%] | [% DM] | [% DM] | [% DM] | [ % DM] | [% DM] |
| Hemp protein | 95 | 17.4 | 14.5 | 78.6 | 3.8 | 0.6 |
| preparation | | | | | | |
| pressed, extracted | | | | | | |
| with 94% by mass | | | | | | |
| ethanol and 6% by | | | | | | |
| mass water | | | | | | |
| Hemp seeds before | 95.4 | 7.6 | 6.4 | 33.9 | 58.3 | 1.0 |
| treatment | | | | | | |

TABLE 3
Functional properties of the hemp protein preparation

| | Protein | | Emulsifying | Gel | Water | Oil |
|---|---|---|---|---|---|---|
| Functional | solubility [%] | | cap. | conc. | binding | binding |
| properties | pH 4.5 | pH 7.0 | [mL/g] | [%] | [mL/g] | [mL/g] |
| Hemp | 11.5 | 13.2 | 223 | 6.0 | 1.6 | 0.8 |
| protein | | | | | | |
| preparation, | | | | | | |
| extracted | | | | | | |
| with | | | | | | |
| ethanol | | | | | | |

### Application Example 1

10 g of the hemp preparation from the exemplary embodiment was mixed with 200 mL water using a Turrax. 8 mL corn oil, 10 g maltodextrin and 1 g sugar were added, and the suspension was homogenised using the Turrax. The emulsion obtained thereby had the consistency of a drink and a very bright milk-like colour, and a mostly neutral taste.

### Application Example 2

400 g of the hemp preparation, produced as in the exemplary embodiment, was mixed with 600 g water, 50 g starch and 10 g salt, extruded in a small extruder at 150° C., and then pumped through a cooling nozzle and cooled down. The extrudate had a very bright colour and a firm gel structure and had a neutral taste.

1. Protein preparation produced from hemp seeds, with
a protein content of more than 65% by mass relative to a dry mass, and
a fat content less than 6% by mass relative to the dry mass,
determined according to a Soxhlet method using hexane as solvent,
wherein the protein preparation has a brightness L* of greater than 70, determined according to CIE-L*a*b* color measurement with a d₉₀ particle size of the protein preparation less than 250 μm, or after grinding of the protein preparation to a d₉₀ particle size less than 250 μm.

2. Protein preparation according to claim 1,
which has a brightness L* greater than 80.

3. Protein preparation according to claim 1,
which has a residual hemp shell content of less than 36% by mass relative to the dry mass.

4. Protein preparation according to claim 1,
in which the protein content is more than 70% by mass.

5. Protein preparation according to claim 1,
in which the fat content is less than 4% by mass.

6. Protein preparation according to claim 1,
in which a sucrose fraction is less than 8% by mass relative to the dry mass.

7. Protein preparation according to claim 1,
in which the emulsifying capacity, determined according to the EC determination method stated in the description, is more than 125 ml/g.

8. Protein preparation according to claim 1,
which at pH 7 has a protein solubility which is between 8% and 50%, determined in each case using the method according to Morr et al. 1985 as cited in the description.

9. Protein preparation according to claim 1,
which has a fraction of ethanol, of >0.001% by mass, but which is less than 1% by mass.

10. Protein preparation according to claim 1,
which has a hexane fraction of >0.0005% by mass, but is less than 0.005% by mass.

11. Protein preparation according to claim 1,
which has a d₉₀ particle size of less than 150 μm.

12. Protein preparation according to claim 1,
which after treatment at 550° C. has an ash content of more than 5% by mass relative to the dry mass.

13. Protein preparation according to claim 1,
to which in addition leguminous proteins from the group consisting of peas, lentils, beans, broad beans, peanuts and soya have been added.

14. An ingredient in foodstuffs, petfood and animal feeds comprising the protein preparation according to claim 1.

15. Method for obtaining a protein preparation from hemp seeds, according to claim 1, with at least the following steps:
shelling the hemp seeds until a residual shell fraction of less than 18% by mass is obtained, or provision of shelled hemp seeds having a residual shell fraction of less than 18% by mass, relative to the dry mass of the hemp seeds in each case;
mechanical partial de-oiling of the shelled hemp seeds, in which an average temperature of the shelled hemp seeds is maintained below 100° C.;
performing one or more extraction steps for the further de-oiling of the partially de-oiled hemp seeds, optionally after grinding or flaking, to a residual oil content of less than 6% by mass, in which a fraction of sucrose is also separated,
wherein the one or more extraction steps is/are carried out with one or more alcohol-water mixtures or with alcohol or hexane as solvent in the presence of water, each having a water content in the range between >6% by mass and <14% by mass for alcohols and between >6% by mass and <10% by mass for hexane, or
wherein the multiple extraction steps are carried out with alcohol or hexane as a first and with water as a second solvent; and
drying the raffinate that is obtained after performance of the one or more extraction steps.

16. Method according to claim 15,
in which the hemp seeds are provided with a residual shell fraction of less than 10% by mass, or are shelled until this residual shell fraction remains.

17. Method according to claim 15,
in which the average temperature of the shelled hemp seeds is maintained below 80° C. during the mechanical partial de-oiling.

18. Method according to claim 15, in which the further de-oiling of the partially de-oiled hemp seeds is carried out until a residual oil content of less than 4% by mass remains.

19. Method according to claim 15, in which the one or more extraction steps is/are carried out with one or more alcohol-water mixtures as solvents or with alcohol as solvent in the presence of water, wherein the water fraction is in the range between >10% by mass and <14% by mass in each case.

20. Method according to claim 15, in which the water fraction is selected to be highest in the first stage of a multistage extraction, and is lower in one or more subsequent stages.

21. Method according to claim 15, in which a temperature of the solvent is selected to be between 30° C. and 750° C. during the performance of the one or more extraction steps.

22. Method according to claim 21,
in which a duration of the contact between the solvent and the partially de-oiled, optionally ground or flaked hemp seeds at temperatures of the solvent of >45° C. is selected to be between 30 minutes and 12 hours.

23. Method according to claim 15, in which the mechanical partial de-oiling is carried out until a residual oil content between >8% by mass and <40% by mass remains.

24. Method according to claim 15, in which the shelled hemp seeds are conditioned before the mechanical partial de-oiling by adjusting the temperature of the seeds to a value between 30° C. and 60° C., and the moisture of the seeds to a water content in the seeds between 2 and 8% by mass.

25. Method according to claim 15, in which the hemp seeds are cooled before and/or during mechanical treatment steps to a temperature <20° C.

26. Method according to claim 15, in which the partially de-oiled, optionally ground or flaked hemp seeds are conditioned before the one or more extraction steps is/are performed by reduction of the moisture to a residual moisture of <8% by mass.

27. Method according to claim 15, in which a particle size of the partially de-oiled hemp seeds is brought to a d₉₀ value of <2 mm before the one or more extraction steps is/are performed, wherein a fine grain fraction with a particle size less than 100 μm constitutes <50% by mass thereof.

28. Method according to claim 15, in which the partially de-oiled hemp seeds are flaked to a flake thickness of <2 mm before the one or more extraction steps is/are performed.

29. Method according to claim 15, in which the drying of the raffinate takes place at a temperature of <120° C.

30. Method according to claim 15, in which the drying of the raffinate is carried out in a vacuum dryer, wherein at the end of the drying the pressure is reduced to <500 mbar.

31. Method according to claim 15, in which a treatment of the raffinate with aqueous enzyme solutions or by fermentation is performed before the raffinate is dried.

32. Method according to claim 15, in which after drying the raffinate is ground to a defined particle size distribution with a d₉₀ value of <500 μm.
